(19) United States
(12) Patent Application Publication
(10) Pub. No.: US 2023/0271660 A1
(43) Pub. Date: Aug. 31, 2023

(54) Tilting Vehicle With a Carrier Device

(71) Applicant: Bayerische Motoren Werke Aktiengesellschaft, Muenchen (DE)

(72) Inventor: Andreas SCHLAYER, Muenchen (DE)

(21) Appl. No.: 18/014,823

(22) PCT Filed: Jul. 9, 2021
(86) PCT No.: PCT/EP2021/069119

§ 371 Date: Jan. 6, 2023

(30) Foreign Application Priority Data
Aug. 31, 2020 (DE) 10 2020 122 627.6

(51) Int. Cl. B62J 7/04; B62J 9/24

(52) U.S. Cl. CPC B62J 7/04; B62J 9/24

(57) ABSTRACT

A tilting vehicle includes a rear section and a carrier device which is connected to the rear section. The carrier device includes a receiving section for the releasable fastening of a luggage container and is connected by at least one first support in the region of the receiving section to the rear section and by at least one second support, which is arranged spaced apart from the at least one first support, to the rear section. The at least one first support is designed in such a manner that it does not transmit any torque.

### BACKGROUND AND SUMMARY OF THE INVENTION

The invention relates to a tilting vehicle with a carrier device.

Tilting vehicles, such as motor bikes or mopeds, usually have a very limited storage space. Additional luggage compartments are therefore often mounted on the vehicle, such as, for example, side cases which are fitted on the sides in the region of the rear wheel.

So-called “top cases” are also known which are placed in the rear region of the tilting vehicle on a holding bridge (also referred to as a luggage bridge). Since the top cases in the loaded state can have a high weight and as a result high static and dynamic forces or torques act on the holding bridges, the holding bridges are normally configured to be solid and manufactured from metal. The holding bridges are frequently formed as a steel tube frame or as aluminum pressure die-cast components.

Above all, a rear fastening point of the holding bridge is subject to particularly high torques during operation of the vehicle. Therefore, this fastening point is normally embodied as very stable, rigid fastening of the holding element to the rear of the tilting vehicle, wherein, however, as a result of the associated high component weight, a weight of the entire vehicle and the location of a center of gravity of the vehicle are also negatively influenced.

One object of the invention is to further develop a fastening for a luggage container on a tilting vehicle, in particular reduce its weight as far as possible.

This object is achieved by a tilting vehicle according to the claimed invention.

A tilting vehicle is accordingly provided, with a rear portion and a carrier device connected to the rear portion, wherein the carrier device comprises a receiving portion for detachable fastening of a luggage container and is connected to the rear portion by way of at least one first support in the region of the receiving portion and is connected to the rear portion by way of at least one second support arranged spaced apart from the at least one support. The at least one support is furthermore formed in such a manner that it does not transmit any torque.

The term tilting vehicle should be understood in the context of this description, among other things, as motor bikes or motor bike-like motor vehicles, such as mopeds, in particular tiltable two-, three- or four-wheeled mopeds, scooters or the like, as well as snow mobiles or quads.

The tilting vehicle therefore has in the rear region the carrier device which is referred to as a holding bridge or luggage bridge and is provided as a carrier for the luggage container. This luggage container can where necessary be connected to the receiving portion of the carrier device or be detached again for dismounting thereof. The receiving portion can form, for example, a plane on which the luggage container is placed from above so that the receiving portion supports the luggage container, for example, from its underside.

The carrier device is connected to the rear portion of the tilting vehicle via the at least one first support and the at least one second support and is thus fastened to the vehicle. The rear portion should be understood as a portion of the vehicle which forms the rear of the tilting vehicle, which rear portion can be formed as a separate component such as, for example, a rear frame or as a (sub-)portion of a vehicle structure, such as, for example, of a vehicle frame and/or a (supporting or non-supporting) vehicle body.

It will be obvious that in each case more than one first or second support can be provided, but for the sake of simplicity at all times a first or a second support is discussed below, which can denote in each case one or more corresponding supports unless this explicitly stated otherwise.

According to one preferred embodiment, the carrier device is connected to the rear portion by way of two first supports and two second supports. The two first supports are preferably arranged in mirror-symmetry to a vehicle center oriented in the longitudinal direction of the vehicle. The same applies to the two second supports which likewise can be arranged in mirror-symmetry to the vehicle center.

In any event, the at least one first support is formed in such a manner that it does not transmit any torque. This means that the at least one first support has at least one (or several) degree(s) of rotational freedom and thus allows a rotational movement or tilting movement of the carrier device, but can nevertheless absorb forces at least in a height direction of the tilting vehicle. A rotational axis of the rotational movement is preferably oriented (preferably horizontally) in the width direction of the vehicle.

This opens up the possibility that a torque brought about, for example, by a vertical movement of the luggage container can lead to the rotational movement of the carrier device in the region of the at least one first support. This can occur in particular if a center of gravity of the luggage container is positioned spaced apart from the one or the several first supports, in particular the center of gravity in a longitudinal direction L of the vehicle is arranged behind the at least one first support.

For example, the rotational movement of the carrier device in the region of the first support can lead to a corresponding elastic deformation of the carrier device along its length, as a result of which the at least one second support is acted upon at least with a tensile force.

In any event, as a result of the constructive configuration, a torque loading of the first support is prevented so that it can correspondingly be formed to be lightweight. Instead of the normally very stiff and rigid configuration of the first support for compensation of this torque, according to embodiments of the invention the torque is compensated for with the aid of the second support which provides a counterforce which acts over the spacing to the first support. As a result of this active lever length, a heavy, in particular (torque-)rigid configuration can also be dispensed with for the at least one second support.

In contrast, the carrier device can have sufficient flexural rigidity. However, this can also be realized with lightweight constructions and lightweight materials such as, for example, lightweight metals or plastics, including fiber-reinforced plastics. This offers, in addition to a significant weight advantage over conventional, rigid and solid embodiments of the carrier device, the advantage that freedom of configuration is significantly expanded in terms of dimensioning and shaping.

For example, the at least one first support can be formed as a fixed bearing, in particular as a ball joint (also referred to as a ball bearing) or cylinder joint (including a rolling joint). Fixed bearings represent what is known as a bivalent bearing which can transmit two bearing reactions. A displacement of the bearing is correspondingly not possible, but no torque is absorbed and instead a rotation is permitted.

Alternatively or additionally, the at least one support can comprise an elastic connection element for uncoupling a movement of the carrier device with respect to the rear portion. This means that the first support comprises only the elastic connection element, but not the fixed bearing. In this case, the elastic connection element can be, for example, a rubber element which likewise does not absorb any torque and instead permits a rotation. Depending on the constructive configuration, the rubber element can additionally enable a limited (lateral) displaceability in terms of its elasticity.

The elastic connection element can, however, also be combined jointly with a fixed bearing.

According to one embodiment, the at least one second support—as described above—can be formed as a rigid connection. The balancing out of a torque load is performed, such as, for example, as a result of a deformation of the carrier device, so that the second support is under tensile load. The rigid configuration can furthermore prevent an undesirable displacement of the carrier device. The at least one second support can alternatively be formed as a fixed bearing.

For example, a spacing of the second support from the first support can have a value between 5 and 100 cm, preferably between 5 and 40 cm.

The luggage container can furthermore be a case, in particular a top case, or a bag.

The invention will be explained in greater detail below on the basis of an exemplary embodiment in comparison with the prior art with reference to the figures.

### BRIEF DESCRIPTION OF THE DRAWINGS prior art.

FIG. 1 shows a side view of a rear region of a tilting vehicle according to the

FIG. 2 shows a side view of a rear region of a tilting vehicle according to the description of an exemplary embodiment of the invention.

### DETAILED DESCRIPTION OF THE DRAWINGS

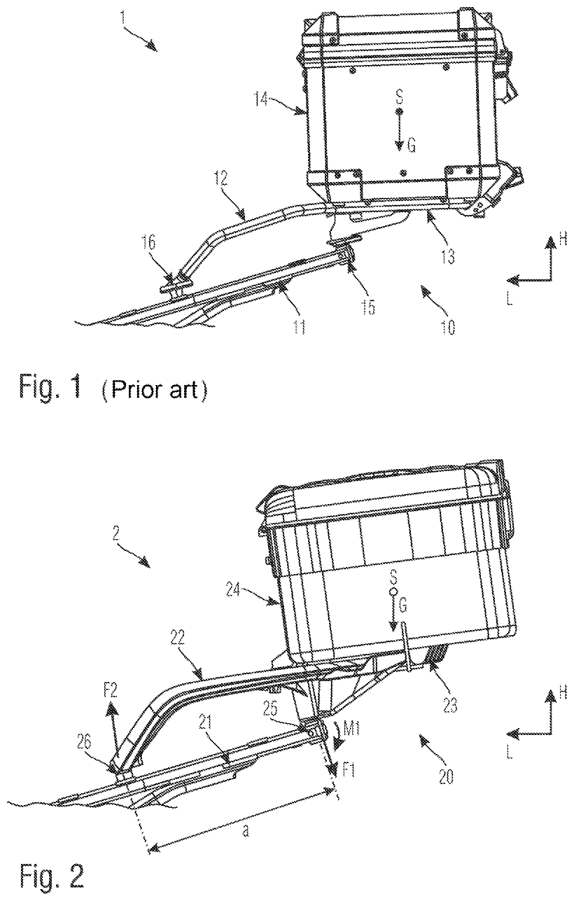

FIG. 1 shows a side view of a rear region 10 of a tilting vehicle 1 (not represented in greater detail) according to the prior art. The tilting vehicle 1 has a rear portion 11 and a carrier device 12 connected to the rear portion 11. The carrier device 12 comprises a receiving portion 13 for detachable attachment of a luggage container 14 and is connected to the rear portion 11 by way of two first supports 15 in the region of the receiving portion 13 and to the rear portion 11 by way of two second supports 16 arranged spaced apart from the first supports 15. The two first supports 15 are formed in each case as a rigid support 15.

The luggage container 14 is, for example, a so-called top case, wherein a center of gravity S of the luggage container 14 (in longitudinal direction L of the vehicle) is arranged far behind the two first supports 15. This has the result that loads and torques resulting from a weight force G must be absorbed by the two rigid first supports 15. This leads to a high load on the two first supports 15 so that these are correspondingly of solid dimensions, as a result of which a vehicle weight is negatively influenced.

As a result of the eccentrically acting weight force G of the luggage container 14, the two first supports 15 are not only acted upon in each case with a compressive force, rather the torque brought about by the weight force G must be absorbed at this point. In the event of a negative acceleration, in each case a tensile force correspondingly acts on the two first supports 15 and an oppositely oriented torque.

In contrast, the second supports 16 are ideally not acted upon. Since the carrier device 12 cannot, however, be assumed to be ideally stiff, it is lengthened by the tensile forces transmitted by it or shortened by propulsive forces. As a result of this movement, the support 16 can only partially also act during torque absorption so that a majority of the torque is absorbed in the support 15.

FIG. 2 shows a side view of a rear region 20 of a tilting vehicle 2, not represented in greater detail, such as, for example, a motor bike or a motor bike-like motor vehicle, according to the description. The tilting vehicle 2 correspondingly has in the rear region 20 a rear portion 21 and a carrier device 22 connected to the rear portion 21 (also referred to as a holding bridge), wherein the carrier device 22 comprises a receiving portion 23 for detachable fastening of a luggage container 24 and is connected to the rear portion 21 by way of two first supports 25 in the region of the receiving portion 23 and is connected to the rear portion 20 by way of two second supports 26 arranged spaced apart from the first supports 25. Moreover, the two first supports 25 are formed in such a manner that these do not transmit any torque.

The luggage container 24 is placed detachably from above onto the receiving portion 23 so that the luggage container 24 is supported on its underside by the receiving portion 23. A center of gravity S of the luggage container 24 is arranged behind the two first supports 25 (in the longitudinal direction L of the vehicle).

The carrier device 22 is connected to the rear portion 21 of the tilting vehicle 2 via the two first supports 25 and the two second supports 26. It will be obvious that in each case more or fewer than the two first 25 or the two second supports 26 can be provided.

The two first supports 25 are arranged in mirror-symmetry to the vehicle center oriented in the longitudinal direction L of the vehicle so that only the front, left-hand, first support 25 is visible in the represented side view, wherein the second first support is covered behind it. The same applies to the two second supports 26 which are likewise arranged in mirror-symmetry to the vehicle center, wherein in the side view only the left-hand, second support 26 is apparent and the right-hand, second support which lies behind it is covered.

The two first supports 25 are formed in such a manner that they do not transmit any torque. In the case of a vertical movement of the luggage container 24, therefore, as a result of the arrangement of its center of gravity S (in longitudinal direction L of the vehicle) behind the first supports 25, a torque M1 is brought about in the region of the two first supports 25 which leads to a rotational movement or tilting movement of the carrier device 22 in the same direction in the region of the first support 25 which is enabled by the described degree of rotational freedom of the two first supports 25.

As a result of the fixing of the carrier device 22 in the two second supports, the torque M1 leads to a corresponding elastic deformation of the carrier device along its length and the tensile force F2 acting upon the second supports 26. For this purpose, the second supports 26 are formed to be, for example, rigid. The great advantage of this embodiment lies in the fact that a high torque load of the two first supports 25 is effectively prevented and these can be formed to be correspondingly lightweight.

Therefore, instead of the normally very stiff and rigid configuration of the first supports 25 for compensation of the torque load, according to embodiments of the invention the torque M1 is compensated for via the two second supports 26 which are arranged at the spacing a from the two first supports 25. As a result of the active lever length of the carrier device 22 over the spacing a, a heavy, in particular (torque-)rigid configuration can also be dispensed with for these two supports 26.

In contrast, the carrier device 22 can have sufficient flexural rigidity which can also be achieved by a lightweight design.

According to the embodiment represented in FIG. 2, the two first supports 25 can be formed in each case as a so-called fixed bearing in the form of a ball joint (also referred to as a ball bearing). A displacement of the two first supports 25 is correspondingly not possible, but no torque is absorbed and instead the described rotational movement of the carrier device 22 is permitted. Of course, the fixed bearing can, however, also be formed in a different manner, for example, as a cylinder joint (including a rolling joint). Alternatively or additionally, the two first supports 25 can in each case also be embodied as elastic connection elements for uncoupling a movement of the carrier device 22 with respect to the rear portion 21.

For example, the spacing a of the second supports 16 from the first supports 25 can have a value between 5 and 100 cm, preferably between 5 and 40 cm.

The luggage container 24 can furthermore be a case, in particular a top case, or a bag.

1-6. (canceled)

7. A tilting vehicle comprising:
a rear portion, and
a carrier device connected to the rear portion, wherein:
the carrier device comprises a receiving portion for detachable fastening of a luggage container and is connected to the rear portion by at least one first support in a region of the receiving portion and is connected to the rear portion by at least one second support arranged spaced apart from the at least one support, and
the at least one support is formed such that the at least one support does not transmit any torque.

8. The tilting vehicle according to claim 7, wherein the at least one first support is formed as a fixed bearing.

9. The tilting vehicle according to claim 8, wherein the at least one first support is formed as a ball joint or a cylinder joint.

10. The tilting vehicle according to claim 7, wherein the at least one first support comprises an elastic connection element for uncoupling a movement of the carrier device with respect to the rear portion.

11. The tilting vehicle according to claim 7, wherein the at least one second support is formed as a rigid connection.

12. The tilting vehicle according to claim 7, wherein a spacing of the at least one second support from the at least one first support has a value between 5 and 100 cm.

13. The titling vehicle of claim 12, wherein the value is between 5 and 40 cm.

14. The tilting vehicle according to claim 7, wherein the luggage container is a case or a bag.

15. The tilting vehicle according to claim 14, wherein the luggage container is a top case.
